(19) United States
(12) Patent Application Publication
(10) Pub. No.: US 2020/0377735 A1
(43) Pub. Date: Dec. 3, 2020

(54) HARD COATING FILM AND IMAGE DISPLAY DEVICE USING THE SAME

(71) Applicant: DONGWOO FINE-CHEM CO., LTD., Iksan-si (KR)

(72) Inventors: Geo San Lim, Seoul (KR); Kwanwook Song, Pyeongtaek-si (KR)

(73) Assignee: DONGWOO FINE-CHEM CO., LTD., Iksan-si (KR)

(21) Appl. No.: 16/994,411

(22) Filed: Aug. 14, 2020

Related U.S. Application Data
(63) Continuation of application No. 15/626,336, filed on Jun. 19, 2017.

(30) Foreign Application Priority Data
Jun. 23, 2016 (KR) 10-2016-0078770

(51) Int. Cl. C09D 4/00; G02B 1/14; C09D 5/00

(52) U.S. Cl. CPC C09D 4/00; C09D 7/61; C09D 5/00; G02B 1/14

(57) ABSTRACT

A hard coating film, including a transparent substrate; and a hard coating layer formed on at least one surface of the transparent substrate, wherein the hard coating film has a pencil hardness of 4H or more as measured by a load of 1 kg and satisfies the physical property defined by the following mathematical formula 1, and an image display device using the same are disclosed.

### CROSS-REFERENCE TO RELATED APPLICATION

This application is a continuation of U.S. application Ser. No. 15/626,336, filed Jun. 19, 2017, which claims priority to Korean Patent Application No. 10-2016-0078770, filed on Jun. 23, 2016, in the Korean Intellectual Property Office, the disclosures of which are hereby incorporated by reference in their entireties.

### TECHNICAL FIELD

The present invention relates to a hard coating film which can be repeatedly folded while having high hardness, and to an image display device having the hard coating film.

### BACKGROUND ART

A hard coating film has been used for protecting the surface of various image display devices including a liquid crystal display device (LCD), an electroluminescence (EL) display device, a plasma display (PD), a field emission display (FED) and the like.

Recently, a flexible display which can maintain display performance even when it is bent like a paper by using a flexible material such as plastic, instead of a conventional glass substrate having no flexibility, gains attention as a next generation display device. In this regard, there is a need for a hard coating film which not only has high hardness and good impact resistance but also has proper flexibility, without curling at the film edges during its production or use.

Korean Patent Application Publication No. 2014-0027023 discloses a hard coating film which comprises a supporting substrate; a first hard coating layer formed on one surface of the substrate and comprising a first photocurable cross-linked copolymer; and a second hard coating layer formed on the other surface of the substrate and comprising a second photocurable cross-linked copolymer and inorganic fine particles distributed in the second photocurable cross-linked copolymer, and the hard coating film exhibits high hardness, impact resistance, scratch resistance, and high transparency.

However, there is a problem that the hard coating film does not have sufficient bending resistance to permit its repetitive folding so that it can be applied to flexible displays.

### DISCLOSURE

### Technical Problem

The present invention has been made in view of the above-mentioned problems, and an object of the present invention is to provide a hard coating film which can be repeatedly folded while having high hardness.

Another object of the present invention is to provide a polarizing plate having the hard coating film.

Still another object of the present invention is to provide a flexible display having the hard coating film.

A further object of the present invention is to provide an image display device having the hard coating film.

### Technical Solution

In accordance with one aspect of the present invention, there is provided a hard coating film, comprising a transparent substrate; and a hard coating layer formed on at least one surface of the transparent substrate,

wherein the hard coating film has a pencil hardness of 4H or more as measured by a load of 1 kg and satisfies the physical property defined by the following mathematical formula 1:

A/B×100<50% [Mathematical Formula 1]

wherein,

A represents the area of strain regions from 0 to 1% in a stress-strain curve, and

B represents the total area under the stress-strain curve.

In one embodiment of the present invention, the hard coating layer may be formed from a hard coating composition comprising a photocurable resin including at least one selected from the group consisting of a photocurable (meth)acrylate oligomer and a photocurable (meth)acrylate monomer; a photoinitiator; and a solvent.

In one embodiment of the present invention, the above hard coating composition may further include inorganic nanoparticles.

In another embodiment of the present invention, the present invention provides a polarizing plate having the hard coating film.

In still another embodiment of the present invention, the present invention provides an image display device having the hard coating film.

In a further embodiment of the present invention, the present invention provides a window of a flexible display having the hard coating film.

### Advantageous Effects

The hard coating film according to the present invention exhibits excellent bending resistance while having high hardness, thereby permitting its repetitive folding. Therefore, the hard coating film according to the present invention can be effectively used for a flexible display.

### BRIEF DESCRIPTION OF THE DRAWING

FIG. 1 is a schematic view showing a stress-strain curve of a hard coating film according to one embodiment of the present invention.

### BEST MODE

Hereinafter, the present invention will be described in more detail.

One embodiment of the present invention relates to a hard coating film, comprising a transparent substrate; and a hard coating layer formed on at least one surface of the transparent substrate,

wherein the hard coating film has a pencil hardness of 4H or more as measured by a load of 1 kg and satisfies the physical property defined by the following mathematical formula 1:

A/B×100<50% [Mathematical Formula 1]

wherein,

A represents the area of strain regions from 0 to 1% in a stress-strain curve, and

B represents the total area under the stress-strain curve.

The above pencil hardness is a value obtained by a pencil hardness test according to JIS K 5400 and indicates the hardness of the hard coating film. In this pencil hardness test, when the measurement operation of the pencil hardness test is repeated 5 times with a load of 1 kg and defective appearance such as a scratch is not recognized more than four times during the measurement, the hardness of the pencil used during the test is defined as a pencil hardness. For example, if the test operation is performed five times using a 3H pencil and the defective appearance does not occur more than four times, the pencil hardness of the material is at least 3H.

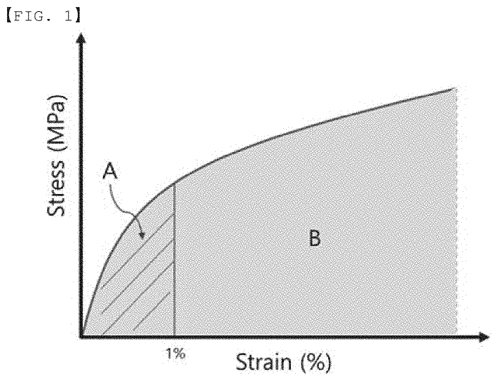

The stress-strain curve can be used interchangeably with terms such as a stress-strain graph and a stress-strain diagram, and the stress-strain curve can be obtained by measuring the load applied to a specimen and the extent of deformation. For example, it can be measured and derived using a Universal Testing Machine (UTM) in accordance with ASTM D882. The stress-strain curve of the hard coating film thus derived may be in the form shown in FIG. 1, wherein A represents the area of strain regions from 0 to 1% (for example, regions from 0 to 1% on the X axis in FIG. 1), and B represents the total area under the stress-strain curve, that is, the toughness of the film.

The hard coating film according to one embodiment of the present invention not only has a pencil hardness of 4H or more as measured at a load of 1 kg but also exhibits excellent bending resistance by adjusting the value of A/B×100 to less than 50%, thereby permitting its repetitive folding.

The pencil hardness and the value of A/B×100 can easily be adjusted by appropriately changing the type and thickness of the transparent substrate constituting the hard coating film, the components and composition contents of the composition forming the hard coating layer, and the thickness of the hard coating layer.

In one embodiment of the present invention, as the transparent substrate, any plastic film can be used as long as it is a plastic film having transparency. For example, the transparent substrate can be a film formed of a polymer such as triacetyl cellulose, acetyl cellulose butyrate, ethylene-vinyl acetate copolymer, propionyl cellulose, butyryl cellulose, acetyl propionyl cellulose, polyester, polystyrene, polyamide, polyetherimide, polyacryl, polyimide, polyether sulfone, polysulfone, polyethylene, polypropylene, polymethylpentene, polyvinyl chloride, polyvinylidene chloride, polyvinyl alcohol, polyvinyl acetal, polyether ketone, polyether ether ketone, polyether sulfone, polymethyl methacrylate, polyethylene terephthalate, polybutylene terephthalate, polyethylene naphthalate, polycarbonate and the like. These polymers may be used alone or in combination of two or more.

The thickness of the transparent substrate is not particularly limited, but may be 10 to 1000 μm, preferably 20 to 150 μm. When the thickness of the transparent substrate is less than 10 μm, the strength of the film is lowered and thus the workability is lowered. When the thickness of the transparent substrate is more than 1000 μm, the transparency is lowered or the weight of the hard coating film is increased.

In one embodiment of the present invention, the hard coating layer can be formed from a hard coating composition comprising a photocurable resin including at least one selected from the group consisting of a photocurable (meth)acrylate oligomer and a photocurable (meth)acrylate monomer; a photoinitiator; and a solvent.

As the photocurable (meth)acrylate oligomer, urethane (meth)acrylate, epoxy (meth)acrylate and the like can be used, and particularly, urethane (meth)acrylate can be used.

The urethane (meth)acrylate can be produced by reacting a polyfunctional (meth)acrylate having a hydroxy group in its molecule and a compound having an isocyanate group in the presence of a catalyst according to a method known in the art. Specific examples of the polyfunctional (meth)acrylate having a hydroxy group in the molecule include 2-hydroxyethyl (meth)acrylate, 2-hydroxyisopropyl (meth)acrylate, 4-hydroxybutyl (meth)acrylate, caprolactone ring-opened hydroxyacrylate, a mixture of pentaerythritol tri/tetra(meth)acrylate, a mixture of dipentaerythritol penta/hexa(meth)acrylate, and the like. Specific examples of the compound having an isocyanate group include trifunctional isocyanates derived from 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexane diisocyanate, 4,4′-methylenebis(cyclohexylisocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis(2,6-dimethylphenyl isocyanate), 4,4′-oxybis(phenylisocyanate), hexamethylene diisocyanate, and an adduct of trimethane propanol and toluene diisocyanate.

Specific examples of the photocurable (meth)acrylate monomer include neopentyl glycol acrylate, 1,6-hexanediol (meth)acrylate, propylene glycol di(meth)acrylate, triethylene glycol di(meth)acrylate, dipropylene glycol di(meth)acrylate, polyethylene glycol di(meth)acrylate, polypropylene glycol di(meth)acrylate, trimethylolpropane tri(meth)acrylate, trimethylolethane tri(meth)acrylate, 1,2,4-cyclohexane tetra(meth)acrylate, pentaglycerol tri(meth)acrylate, pentaerythritol tetra(meth)acrylate, pentaerythritol tri(meth)acrylate, dipentaerythritol tri(meth)acrylate, dipentaerythritol penta(meth)acrylate, dipentaerythritol tetra(meth)acrylate, dipentaerythritol hexa(meth)arylate, tripentaerythritol tri(meth)acrylate, tripentaerythritol hexa(meth)acrylate, bis(2-hydroxyethyl)isocyanurate di(meth)acrylate, hydroxyethyl (meth)acrylate, hydroxypropyl (meth)acrylate, hydroxybutyl (meth)acrylate, isooctyl (meth)acrylate, isodecyl (meth)acrylate, stearyl (meth)acrylate, tetrahydrofurfuryl (meth)acrylate, phenoxyethyl (meth)acrylate, isobornyl (meth)acrylate, and the like.

The photocurable resin may include a photocurable (meth)acrylate oligomer and a photocurable (meth)acrylate monomer, either singly or in combination of two or more.

The photocurable resin can be used in an amount of 1 to 80% by weight, preferably 5 to 50% by weight, based on 100% by weight of the entire hard coating composition. If the amount of the photocurable resin is less than 1% by weight, it is difficult to form a coating film, or even if it is formed, a hard coating layer having a sufficient level of hardness cannot be produced. If the amount of the photocurable resin exceeds 80% by weight, there arises a problem that curling becomes severe due to the shrinkage of the coating film formed after coating and curing of the hard coating composition.

The photoinitiator is capable of forming radicals by light irradiation and can be used without limitation as long as it is used in the technical field. For example, hydroxy ketones, aminoketones, hydrogen-abstraction type photoinitiators and the like can be used.

Specific examples of the photoinitiator include 2-methyl-1-[4-(methylthio)phenyl]2-morpholinopropanone-1, diphenylketone, benzyldimethylketal, 2-hydroxy-2-methyl-1-phenyl-1-one, 4-hydroxycyclohexyl phenyl ketone, 2,2-dimethoxy-2-phenyl-acetophenone, anthraquinone, fluorene, triphenylamine, carbazole, 3-methylacetophenone, 4-chloroacetophenone, 4,4-dimethoxyacetophenone, 4,4-diaminobenzophenone, 1-hydroxycyclohexyl phenyl ketone, benzophenone, diphenyl(2,4,6-trimethylbenzoyl)phosphine oxide and the like. The photoinitiators exemplified above can be used alone or in combination of two or more.

The content of the photoinitiator is not particularly limited, and may be, for example, 0.1 to 10% by weight, preferably 1 to 5% by weight based on 100% by weight of the hard coating composition. If the content is less than 0.1% by weight, the curing may not proceed sufficiently and thus it may be difficult to realize the mechanical properties or adhesive properties of the coating layer. If the content exceeds 10% by weight, problems such as adhesion failure, cracks, or curls can occur due to curing shrinkage.

The solvent may be used without particular limitation as long as it is used in the technical field. Specific examples of the solvent may include alcohols (methanol, ethanol, isopropanol, butanol, methyl cellosolve, ethyl cellosolve, etc.), ketones (methyl ethyl ketone, methyl butyl ketone, methyl isobutyl ketone, diethyl ketone, dipropyl ketone, cyclohexanone, etc.), acetates (ethyl acetate, propyl acetate, n-butyl acetate, tertiary butyl acetate, methyl cellosolve acetate, ethyl cellosolve acetate, propylene glycol monomethyl ether acetate, propylene glycol monoethyl ether acetate, propylene glycol monopropyl ether acetate, methoxybutyl acetate, methoxypentyl acetate, etc.), hexanes (hexane, heptane, octane, etc.), benzenes (benzene, toluene, xylene, etc.), ethers (diethylene glycol dimethyl ether, diethylene glycol diethyl ether, diethylene glycol dipropyl ether, diethylene glycol dibutyl ether, propylene glycol monomethyl ether, etc.) and the like. The solvents exemplified above may be used alone or in combination of two or more.

The solvent may be contained in an amount of 10 to 95% by weight, based on 100% by weight of the hard coating composition. If the amount of the solvent is less than 10% by weight, not only the viscosity may increase to deteriorate workability but also the swelling of the transparent substrate cannot be sufficiently progressed. If the amount of the solvent is higher than 95% by weight, there is a disadvantage that drying process may take a long time and the economical efficiency is lowered.

The hard coating composition may further include inorganic nanoparticles.

The inorganic nanoparticles are components used for further improving mechanical properties, particularly hardness, without inhibiting optical properties, and have an average particle size of 1 to 100 nm, preferably 5 to 50 nm.

If the particle size is less than the above range, aggregation occurs in the composition, and thus a uniform coating film cannot be formed and the above effect cannot be expected. Conversely, if the particle size exceeds the above range, not only the optical properties of the finally obtained coating film are lowered but also the mechanical properties are deteriorated.

Materials of these inorganic nanoparticles can be metal oxides, and one or more selected from the group consisting of SiO₂, Al₂O₃, ZnO, ZrO₂, BaTiO₃, TiO₂, Ta₂O₅, Ti₃O₅, ITO, IZO, ATO, ZnO—Al, Nb₂O₃, SnO and MgO can be used. Preferably, SiO₂, Al₂O₃, ZrO₂ or the like can be used. The above-mentioned inorganic nanoparticles can be directly produced or commercially available. In the case of commercially available products, the inorganic nanoparticles dispersed in an organic solvent at a concentration of 20 to 60% by weight can be used.

The inorganic nanoparticles may be contained in an amount of 40% by weight or less, for example, 10 to 30% by weight, based on 100% by weight of solid content in the entire hard coating composition. If the amount of the inorganic nanoparticles is less than 10% by weight, the mechanical properties such as abrasion resistance, scratch resistance and pencil hardness may not be sufficient. If the amount of the inorganic nanoparticles exceeds 40% by weight, the curability is disturbed, and thus mechanical properties are rather lowered and the appearance can be deteriorated.

In addition to the above-mentioned components, the hard coating composition may further include components commonly used in the technical field, such as a leveling agent, an ultraviolet stabilizer, a heat stabilizer, an antioxidant, a surfactant, a lubricant, an anti-fouling agent, and the like.

The leveling agent is used for improving the coating property during coating of the above hard coating composition and lowering the coefficient of static friction of the surface of the hard coating layer, and materials having a high surface slip property after curing of the coating layer can be used.

As the leveling agent, a silicone type leveling agent, a fluorine type leveling agent, an acrylic polymer type leveling agent and the like can be used. Among them, a silicon type leveling agent capable of maintaining a low surface energy by being unevenly distributed on a surface side after coating of the hard coating composition is preferred. Examples of commercially available leveling agents include BYK-306, BYK-307, BYK-310, BYK-313, BYK-333, BYK-371, BYK-377, BYK-378, BYK-3440, BYK-UV3500, BYK-3550 and BYK-UV3570 (BYK Chemie), TEGO Glide 100, TEGO Glide 450, TEGO Glide B1484, TEGO Glide 420, TEGO Glide 482, TEGO Glide 410, TEGO Glide 415 (Degussa), and the like.

The leveling agent may be contained in an amount of 0.01 to 1% by weight based on 100% by weight of the hard coating composition. If the content of the leveling agent is less than 0.01% by weight, the leveling agent is not sufficiently distributed on the surface and thus it is difficult to lower the friction coefficient of the surface, whereas the content exceeds 1% by weight, compatibility with other components decreases and thus sedimentation may occur, or the economical efficiency relative to performance may be reduced.

The hard coating layer can be formed by coating the hard coating composition onto one surface or both surfaces of a transparent substrate, followed by drying and UV curing.

The hard coating composition can be coated onto the transparent substrate by suitably using a known method such as die coater, air knife, reverse roll, spray, blade, casting, gravure, micro gravure, spin coating, etc.

After the hard coating composition is coated onto the transparent substrate, a drying process may be carried out by vaporizing volatiles at a temperature of 30 to 150° C. for 10 seconds to one hour, more specifically 30 seconds to 30 minutes, followed by UV radiation curing. The UV curing may be carried out by the irradiation of UV-rays at about 0.01 to 10 J/cm², particularly 0.1 to 2 J/cm².

At this time, in order to improve the surface hardness of the hard coating layer, it is advantageous to perform the UV curing in a state where the oxygen concentration is maintained at 500 ppm or less, particularly, under a nitrogen atmosphere. For example, by purging nitrogen on the surface of the coating layer during UV curing, the oxygen concentration can be maintained at 500 ppm or less.

The thickness of the hard coating layer formed through the above process may be specifically 5 to 15 μm. When the thickness of the hard coating layer is within the above range, it is possible to exhibit excellent bending resistance while exhibiting excellent hardness.

One embodiment of the present invention relates to a polarizing plate having the hard coating film described above. The polarizing plate according to one embodiment of the present invention can be produced by laminating the above-mentioned hard coating film on at least one surface of a polarizing film.

The polarizing film is not particularly limited, and for example, a uniaxially stretched film obtained by adsorbing a dichroic substance such as iodine or a dichroic dye onto a hydrophilic polymer film such as a polyvinyl alcohol-based film, a partially saponified ethylene-vinyl acetate copolymer-based film or the like; or a polyene-based oriented film such as a dehydrated product of polyvinyl alcohol or a dehydrochlorinated product of polyvinyl chloride may be used. Specifically, the film composed of a polyvinyl alcohol based film and a dichroic material such as iodine may be used. Thickness of these polarizing films is not particularly limited, but is generally 5 to 80 μm.

One embodiment of the present invention relates to an image display device having the above-mentioned hard coating film, in particular, a flexible display. For example, by incorporating the polarizing plate having the hard coating film of the present invention in an image display device, it is possible to manufacture various image display devices having excellent visibility. Further, the hard coating film of the present invention can be used as a window of a flexible display.

The hard coating film according to one embodiment of the present invention may be used in liquid crystal devices (LCDs) of various operation modes, such as reflective type, transmissive type, transflective type LCD, TN type, STN type, OCB type, HAN type, VA type, IPS type and the like. The hard coating film according to one embodiment of the present invention can also be used for various image display devices such as a plasma display, a field emission display, an organic EL display, an inorganic EL display, and electronic paper.

Hereinafter, the present invention will be described in more detail with reference to examples and experimental examples. It should be apparent to those skilled in the art that these examples and experimental examples are for illustrative purposes only, and the scope of the present invention is not limited thereto.

### Preparation Example 1: Preparation of Hard Coating Composition

20 parts by weight of urethane acrylate (10 functional, Miramer MU 9500, Miwon Specialty Chemicals), 20 parts by weight of pentaerythritol triacrylate (trifunctional, Miwon Specialty Chemicals), 20 parts by weight of nano silica sol (12 nm, solid content 40%, V 8802, Catalysts and Chemicals), 30 parts by weight of methyl ethyl ketone, 7 parts by weight of propylene glycol monomethyl ether, 2.5 parts by weight of a photoinitiator (I-184, Ciba) and 0.5 parts by weight of a leveling agent (BYK3570, BYK Chemie) were mixed using a stirrer and filtered using a polypropylene (PP) filter to prepare a hard coating composition.

### Preparation Example 2: Preparation of Hard Coating Composition

10 parts by weight of urethane acrylate (10 functional, Miramer MU 9500, Miwon Specialty Chemicals), 10 parts by weight of pentaerythritol triacrylate (trifunctional, Miwon Specialty Chemicals), 50 parts by weight of nano silica sol (12 nm, solid content 40%, V 8802, Catalysts and Chemicals), 20 parts by weight of methyl ethyl ketone, 7 parts by weight of propylene glycol monomethyl ether, 2.5 parts by weight of a photoinitiator (I-184, Ciba) and 0.5 parts by weight of a leveling agent (BYK3570, BYK Chemie) were mixed using a stirrer and filtered using a polypropylene (PP) filter to prepare a hard coating composition.

### Preparation Example 3: Preparation of Hard Coating Composition

20 parts by weight of urethane acrylate (bifunctional, Miramer PU210, Miwon Specialty Chemicals), 50 parts by weight of ethylene oxide-containing acrylate (trifunctional, Miramer M3190, Miwon Specialty Chemicals), 20 parts by weight of methyl ethyl ketone, 7 parts by weight of propylene glycol monomethyl ether, 2.5 parts by weight of a photoinitiator (I-184, Ciba) and 0.5 parts by weight of a leveling agent (BYK3570, BYK Chemie) were mixed using a stirrer and filtered using a polypropylene (PP) filter to prepare a hard coating composition.

### Example 1: Preparation of Hard Coating Film

The hard coating composition prepared in Preparation Example 1 was coated on one side of a polyimide film (50 μm) so as to have a thickness of 10 μm after curing. And then, the composition was coated on the one side by drying the solvent and irradiating with an integrated amount (500 J/cm²) of ultraviolet ray. Similarly, the composition was coated on the other side of the polyimide film so as to have a thickness of 10 μm after curing, followed by drying and UV curing to prepare a hard coating film.

### Example 2: Preparation of Hard Coating Film

The hard coating film was prepared in the same manner as in Example 1, except that the thickness of the hard coating layers on both sides in Example 1 was changed to 8 μm.

### Example 3: Preparation of Hard Coating Film

The hard coating film was prepared in the same manner as in Example 1, except that the thickness of the hard coating layers on both sides in Example 1 was changed to 15 μm.

### Example 4: Preparation of Hard Coating Film

The hard coating composition of Preparation Example 1 in Example 1 was coated on one side of a polyimide film (50 μm) so as to have a thickness of 10 μm after curing, Then, the composition was coated on the one side only by drying the solvent and irradiating with an integrated amount (500 J/cm²) of ultraviolet ray to prepare a hard coating film.

### Comparative Example 1: Preparation of Hard Coating Film

The hard coating film was prepared in the same manner as in Example 1, except that the hard coating composition in Example 1 was changed to the hard coating composition of Preparation Example 2.

### Comparative Example 2: Preparation of Hard Coating Film

The hard coating film was prepared in the same manner as in Example 1, except that the hard coating composition in Example 1 was changed to the hard coating composition of Preparation Example 3.

### Comparative Example 3: Preparation of Hard Coating Film

The hard coating film was prepared in the same manner as in Example 1, except that the thickness of the hard coating layers on both sides in Example 1 was changed to 3 μm.

### Comparative Example 4: Preparation of Hard Coating Film

The hard coating film was prepared in the same manner as in Example 1, except that the thickness of the hard coating layers on both sides in Example 1 was changed to 20 μm.

### Experimental Example 1: Evaluation of Physical Properties

The physical properties of the hard coating films prepared in Examples and Comparative Examples were each evaluated by the following evaluation methods, and the results are shown in Table 1 below.

(1) Stress-Strain Curve

After cutting the hard coating film to a width of 5 mm and a length of 10 cm, the film was installed in the longitudinal direction so that the distance between UTM jigs was 5 cm. That is, the area of the sample to be measured was 5 mm in width and 5 cm in length. In the measurement, the jig was pulled at a speed of 4 mm/min, and the stress and strain values were measured until the film was broken, and thereby the stress-strain curve was measured.

(2) Pencil Hardness

After setting the pencil in a direction of 45 degrees under a load of 1 kg, the hard coating film was fixed on the glass, and then the hard coating side of the film was evaluated five times with a pencil having each pencil hardness. Then, the hardness of the pencil that does not scratch the surface more than four times was expressed as the pencil hardness.

(3) Bending Resistance

In the case of the hard coating films of Examples 1 to 3, the evaluation was carried out irrespective of the direction, and in the case of the hard coating film of Example 4, the hard coating layer of the hard coating film was set to direct inwardly, and the films were folded in half so that the distance between the film surfaces was 6 mm and the film was spread again. These processes were repeated 200,000 times and then it was confirmed with the naked eye whether or not cracks occurred in the folded portion, and thereby the bending resistance was evaluated.

<Evaluation Criteria>

OK: No occurrence of crack in the folded portion

NG: Occurrence of cracks in the folded portion

TABLE 1

| | A | B | A/B × 100 | Pencil | Bending |
|---|---|---|---|---|---|
| | (MPa) | (MPa) | (%) | hardness | resistance |
| Example 1 | 41.2 | 212.7 | 19.4 | 5H | OK |
| Example 2 | 38.1 | 323.2 | 11.8 | 4H | OK |
| Example 3 | 47.8 | 117.7 | 40.6 | 7H | OK |
| Example 4 | 32.5 | 411.3 | 7.9 | 4H | OK |
| Comparative | 52.0 | 89.4 | 58.2 | 6H | NG |
| Example 1 | | | | | |
| Comparative | 40.8 | 492.0 | 8.3 | 2H | OK |
| Example 2 | | | | | |
| Comparative | 62.1 | 868.0 | 7.2 | 2H | OK |
| Example 3 | | | | | |
| Comparative | 58.0 | 72.3 | 80.2 | 8H | NG |
| Example 4 | | | | | |

As can be seen from Table 1, it was confirmed that the hard coating films of Examples 1 to 4 having a pencil hardness of 4H or more and satisfying physical property defined as A/B×100<50% exhibited excellent bending resistance without crack in the folded portion even when folded 200,000 times while having high hardness. On the other hand, in the case of Comparative Examples 1 to 4, the pencil hardness was low or the bending resistance was poor.

Although particular embodiments of the present invention have been shown and described in detail, it will be obvious to those skilled in the art that these specific techniques are merely preferred embodiments, and various changes and modifications may be made to the invention without departing from the spirit and scope of the invention.

The substantial scope of the present invention, therefore, is to be defined by the appended claims and equivalents thereof.

### DESCRIPTION OF REFERENCE NUMERALS

A: Area of strain regions from 0 to 1% in a stress-strain curve
B: Total area under the stress-strain curve.

1. A foldable display device having a hard coating film,
wherein the hard coating film comprises a transparent substrate; and a hard coating layer formed on at least one surface of the transparent substrate,
wherein the hard coating film has a pencil hardness of 4H or more as measured by a load of 1 kg and satisfies the physical property defined by the following mathematical formula 1:
A/B×100<50% Mathematical Formula 1
wherein,
A represents the area of strain regions from 0 to 1% in a stress-strain curve, and
B represents the total area under the stress-strain curve.

2. The foldable display device of claim 1, wherein the hard coating layer is formed from a hard coating composition comprising a photocurable resin including at least one selected from the group consisting of a photocurable (meth)acrylate oligomer and a photocurable (meth)acrylate monomer; a photoinitiator; and a solvent.

3. The foldable display device of claim 2, wherein the hard coating composition further includes inorganic nanoparticles.

4. The foldable display device of claim 1, wherein the hard coating layer has a thickness of 5 to 15 μm.

5. The foldable display device of claim 1, wherein the transparent substrate is a polyimide film.

6. The foldable display device of claim 1, wherein the transparent substrate is a polyethylene terephthalate film.
